(19) United States
(12) Patent Application Publication
(10) Pub. No.: US 2023/0300090 A1
(43) Pub. Date: Sep. 21, 2023

(54) ADAPTIVE RESIZING OF AUDIO JITTER BUFFER BASED ON CURRENT NETWORK CONDITIONS

(71) Applicant: GOOGLE LLC, Mountain View, CA (US)

(72) Inventor: Chiong Ching Lai, Sunnyvale, CA (US)

(21) Appl. No.: 18/016,493

(22) PCT Filed: Jul. 20, 2020
(86) PCT No.: PCT/US2020/042707

§ 371 Date: Jan. 17, 2023

(51) Int. Cl. H04L 49/9005; H04L 43/087; H04L 43/0882; H04L 65/61

(52) U.S. Cl. CPC H04L 49/9005; H04L 43/087; H04L 43/0882; H04L 65/61

(57) ABSTRACT

In a streaming media system, a client device includes an adjustable-size jitter buffer to buffer audio packets of a stream. A buffer controller of the client device operates to determine a representation of a current condition of the network, such as through statistical analysis to generate a histogram or probability density function representative of measured differences between arrival times of successive audio packets at the client device, either since a start of a streaming session or over a sliding time window. The buffer controller then selects an updated size for the jitter buffer based on the representation of the current condition of the network and implements the updated size, either in one adjustment or over time at a size adaptation rate based on a programmable adjustment duration, so as to balance buffer latency and dropped packet rate in view of the current network conditions.

### BACKGROUND

Networked multimedia streaming systems often utilize the streaming of packets containing audio content from a server to a client device for real-time playback of the audio content at the client device. Ideally, successive packets from the stream arrive at fixed intervals at the client device. However, congestion of the network connecting the server and the client device can introduce jitter in the arrival of successive packets at the client device, and in some instances can even result in packet loss in the network. To compensate for this jitter, the client device typically utilizes a jitter buffer to temporarily buffer a subset of recently received packets before they are accessed by a decoder of the client device, which results in an averaging, or smoothing, of recent differences in packet arrival times.

### SUMMARY OF EMBODIMENTS

The proposed solution might in particular be implemented in a streaming media system, in which a server transmits a stream of audio packets to a client device. The client device may include the adjustable-size jitter buffer to buffer audio packets of the stream. A buffer controller of the client device operates to determine the representation of a current condition of the network, i.e. at least one representation parameter indicative of a current network condition, such as through statistical analysis to generate a histogram or probability density function representative of measured differences between arrival times of successive audio packets at the client device, either since a start of a streaming session or over a sliding time window. In an exemplary embodiment, the buffer controller then selects an updated size for the jitter buffer based on the representation of the current condition of the network and implements the updated size, either in one adjustment or over time at a size adaptation rate based on a programmable adjustment duration, so as to balance buffer latency and dropped packet rate in view of the current network conditions.

In accordance with one aspect, a method includes receiving a stream of audio packets at a device via a network; buffering audio packets of the stream at a jitter buffer of the device; and dynamically adjusting a size of the jitter buffer based on a representation of a current condition of the network.

The method may also include determining the representation of the current condition of the network based on a congestion level of the network.

The method may also include determining the representation of the current condition of the network based on measured differences between arrival times of successive audio packets of the stream. The method may further include determining the representation of the current condition of the network comprises determining the representation of the current condition based on a statistical analysis of the measured differences between arrival times of successive audio packets. In some implementations, the representation of the current condition comprises one of a histogram or a probability density function determined from the measured differences between arrival times of successive audio packets.

The method may further include determining a first subset of audio packets of the stream of audio packets arriving within a first period based on a first bin of the histogram; determining a second subset of audio packets of the stream of audio packets arriving between the first period and a second period based on a second bin of the histogram; and determining a percentile of total packets received based on the first subset of audio packets and the second subset of audio packets. In some implementations, dynamically adjusting the size of the jitter buffer includes adjusting the size of the jitter buffer based on the percentile of total packets received satisfying a target percentile of total packets received. In some implementations, the statistical analysis is performed for one of: measured differences between arrival times of successive audio packets since a start of a session for the stream; or measured differences between arrival times of successive audio packets over a sliding time window.

The method may also include selecting one or more bins of a histogram corresponding to a number of audio packets of the stream of audio packets received based on a target percentile of total packets received; and interpolating the one or more selected bins corresponding to the number of audio packets of the stream of audio packets received. In some implementations, dynamically adjusting the size of the jitter buffer includes adjusting the size of the jitter buffer based on the interpolation, wherein a value of the interpolating number of audio packets of the stream of audio packets received comprise an integer value mapping to the size of the jitter buffer. In some implementations, the statistical analysis includes use of weighting to favor more recent measured differences over less recent measured differences.

The method may also include determining a size adaptation rate for adjusting the size of the jitter buffer from a current size to a target size. In some implementations, dynamically adjusting the size of the jitter buffer includes adjusting the size of the jitter buffer to the target size at the size adaptation rate. In some implementations, the size adaptation rate is based on a programmable duration over which the size of the jitter buffer is to be adapted to the target size.

In accordance with yet another aspect, a device may include a network interface configured to couple to a network to receive a stream of audio packets, a jitter buffer configured to buffer audio packets of the stream, the jitter buffer having an adjustable size, and a buffer controller coupled to the network interface and the jitter buffer, the buffer controller configured to dynamically adjust the size of the jitter buffer based on a representation of a current condition of the network.

In some implementations, the buffer controller is configured to determine the representation of the current condition of the network based on measured differences between arrival times of successive audio packets of the stream. In some other implementations, the buffer controller is further configured to determine the representation of the current condition based on a statistical analysis of the measured differences between arrival times of successive audio packets.

In some implementations, the representation of the current condition comprises one of a histogram or a probability density function determined from the measured differences between arrival times of successive audio packets. The buffer controller is further configured to determine a first subset of audio packets of the stream of audio packets arriving within a first period based on a first bin of the histogram; determine a second subset of audio packets of the stream of audio packets arriving between the first period and a second period based on a second bin of the histogram; and determine a percentile of total packets received based on the first subset of audio packets and the second subset of audio packets. In some implementations, dynamically adjusting the size of the jitter buffer includes adjusting the size of the jitter buffer based on the percentile of total packets received satisfying a target percentile of total packets received.

In some implementations, the buffer controller is further configured to perform the statistical analysis for one of: measured differences between arrival times of successive audio packets since a start of a session for the stream; and measured differences between arrival times of successive audio packets over a sliding time window.

In some implementations, the buffer controller is further configured to: determine a size adaptation rate for adjusting the size of the jitter buffer from a current size to a target size; and dynamically adjust the size of the jitter buffer by adjusting the size of the jitter buffer to the target size at the size adaptation rate. In some implementations, the size adaptation rate is based on a programmable duration over which the size of the jitter buffer is to be adapted to the target size.

### BRIEF DESCRIPTION OF THE DRAWINGS

The present disclosure is better understood, and its numerous features and advantages made apparent to those skilled in the art by referencing the accompanying drawings. The use of the same reference symbols in different drawings indicates similar or identical items.

FIG. 1 is a block diagram of a streaming media system implementing adaptive jitter buffer sizing to accommodate changing network conditions in accordance with some embodiments.

FIG. 2 illustrates an example method for adaptive jitter buffer sizing to accommodate changing network conditions in accordance with some embodiments.

FIG. 3 illustrates an example implementation of the method of FIG. 2 using statistical analysis of differences between packet arrival times to determine a representation of current network conditions for use in adapting a jitter buffer size to current network conditions.

### DETAILED DESCRIPTION

In conventional approaches, the jitter buffer of a client device receiving a packetized audio stream has a fixed size. However, network conditions often are variable. As such, if the fixed size of the jitter buffer is relatively large in view of the current jitter being exhibited by the network, the overly large jitter buffer typically will introduce excessive latency in the decoding process, which can lead to unsatisfactory user experience. Conversely, if the fixed size of the jitter buffer is relatively small in view of current network conditions, this can result in an excessive number of dropped packets at the client device, which also can lead to unsatisfactory user experience. Accordingly, as described herein, in at least one embodiment a client device employs a jitter buffer that has a variable size that is dynamically adjusted to reflect current network conditions and thus provide a balance between decoding latency and risk of dropped packets that is suited to the current jitter observed in the network. To this end, in some embodiments, the client device performs a statistical analysis of network arrival times of the packets (that is, packet arrival times) to determine a statistical representation of the current network jitter. This statistical representation can include, for example, at least one representation parameter such as, a congestion level of the network, measured time differences between arrival time of successive packets, a histogram, or a probability density function, or any combination thereof. Using this statistical representation (e.g., at least one representation parameter), the client device can determine a target size for the jitter buffer and adjust the jitter buffer size accordingly. Further, in some embodiments, the client device controls an adaptation rate of the jitter buffer size; that is, the rate at which the jitter buffer size adaptation reacts to changing network conditions is tunable. Thus, the client device may support high reliability and low latency packet processing by providing a jitter buffer with a current size tuned to current network conditions.

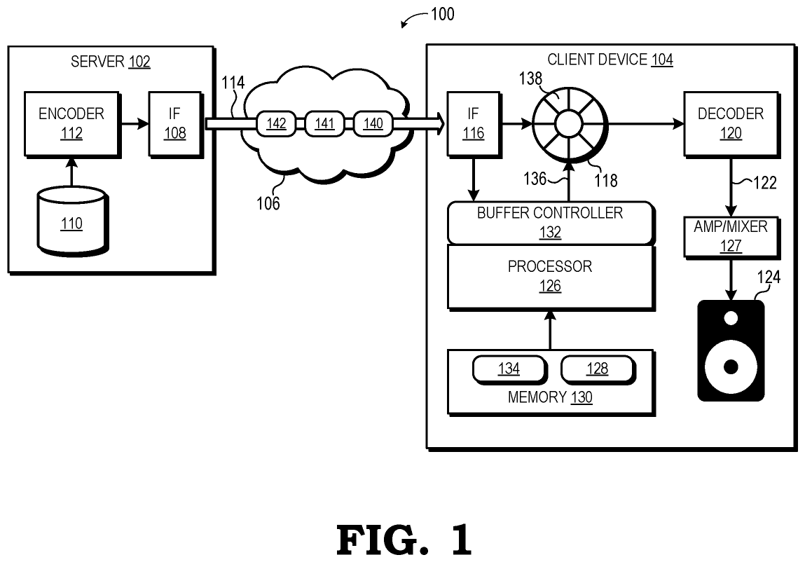

FIG. 1 is a block diagram of a streaming media system 100 implementing adaptive jitter buffer sizing to accommodate changing network conditions in accordance with some embodiments. The streaming media system 100 includes a server 102 coupled to a client device 104 via a network 106. The network 106 can include, for example, the Internet or other public-access network, a wired or wireless wide area network (WAN), a wired or wireless local area network (LAN), a wired or wireless personal area network (PAN), a fourth-generation (4G) Long-Term Advanced (LTE) cellular network, a fifth-generation (5G) new radio (NR) cellular network, or combinations thereof.

The server 102 includes a network interface 108 coupled to the network 106, a real-time media source 110, and an audio encoder 112. In the example of FIG. 1, the real-time media source 110 generates or otherwise provides real-time media content for transmission to the client device 104. To illustrate, the real-time media source 110 can include, for example, a cloud-based video game being executed at the server 102 based on player inputs received from the client device 104 via the network 106, with the video game generating both a stream of video frames and a stream of accompanying audio frames for transmission to the client. As another example, the real-time media source 110 can include a video-conferencing application that distributes video and audio streams among the various participant's client devices. As yet another example, the real-time media source 110 can include the forwarding transmission of the voice content of a Voice-over-Internet Protocol (VoIP) or other packet-based voice calls in a mobile cellular system. The audio encoder 112 operates to encode the audio content stream from the real-time media source 110 and provide the resulting encoded audio stream to the network interface 108, whereupon the network interface 108 packetizes the encoded audio stream and transmits the resulting audio packets to the client device 104 via the network 106 as part of a packetized audio stream 114.

The client device 104 represents any of a variety of electronic devices utilized to playback the audio content of the audio stream 114, or to decode and forward the audio content for playback by yet another electronic device. Examples of the client device 104 include a mobile telephone, a desktop computer, a laptop computer, a tablet computer, a game console, a “smart” television, a “smart” watch, an automotive informational/entertainment system, and the like. The client device 104 includes a network interface 116 to receive the audio packets of the audio stream 114, a jitter buffer 118 (e.g., a circular buffer) to temporarily buffer a sliding subset of the recently received audio packets, and an audio decoder 120 that operates to sequentially decode audio packets from the jitter buffer 118 in a specified order (e.g., received order, sequential order based on timestamp, etc.) to generate a corresponding decoded audio segment of an output decoded audio signal 122 (e.g., a pulse-code-modulation (PCM) digital signal) that can be either directly converted to one or more analog audio signals used to drive at least one speaker 124 (e.g., via a digital-to-analog converter, or DAC) or processed further, such as by a digital amplifier/mixer 127, before being converted to one or more analog speaker signals for driving the at least one speaker 124.

The audio decoder 120 can be implemented as one or more processors 126 executing audio decoding software 128 stored in a system memory 130 or another non-transitory computer-readable medium. To illustrate, the audio decoding software 128 can be implemented as, for example, an Opus Interactive Audio Codec or other well-known or proprietary software-based codec. In other embodiments, the audio decoder 120 can be implemented as hardcoded or programmable logic, such as an application-specific integrated circuit (ASIC) or field-programmable gate array (FPGA) configured to perform the functionality described herein. In still other embodiments, the audio decoder 120 can be implemented as a combination of a processor executing software and specific hardcoded/programmable logic.

In at least one embodiment, the network 106 is a combination of one or more packet-switched networks, and thus is subject to congestion, routing errors, buffer overflows, and other network issues that can result in one or more of the audio packets of the audio stream 114 arriving late (that is, not received by the client device 104 in time to be processed for playback in its corresponding decoding timeslot). Conventionally, jitter buffers used to buffer packetized audio streams have a fixed size. However, network conditions of the network 106 often are variable, and thus the jitter in the timing of received audio packets is commensurately variable. As such, a fixed-size jitter buffer may be excessively large given the current network conditions, leading to excessively decoding latency, or excessively small given the current network conditions, leading to excessive dropped packet rates.

Accordingly, in at least one the jitter buffer 118 is implemented to have a variable size that is dynamically adjusted or otherwise adapted to reflect current network conditions of the network 106 and thus provide a balance between latency and risk of dropped packets that is suited to the current jitter observed in the network 106. To this end, the client device 104 includes a buffer controller 132 implemented as, for example, implemented as one or more processors 126 executing a driver or other software 134 stored in a system memory 130 or another non-transitory computer-readable medium, as hardcoded or programmable logic, such as an application-specific integrated circuit (ASIC) or field-programmable gate array (FPGA) configured to perform the functionality described herein, or as a combination of a processor executing software and specific hardcoded/programmable logic. The buffer controller 132 performs a statistical analysis of network arrival times of packets (that is, a packet arrival time) of the audio stream 114 (represented by, for example, audio packets 140, 141, and 142) to determine a statistical representation of the current network jitter. This statistical representation can include, for example, a histogram of network arrival times or a probability density function of network arrival times. Using this statistical representation, the buffer controller 132 determines a target size for the jitter buffer 118 and adjust the jitter buffer size accordingly. Further, in some embodiments, the buffer controller 132 also controls a rate at which the jitter buffer size is adapted to changing network conditions.

The buffer controller 132 can use any of a variety of techniques to set a current size of the jitter buffer 118. In some embodiments, the jitter buffer 118 is implemented as a circular buffer, linked list, or other data structure in a memory (e.g., system memory 130) or other storage component, and the buffer controller 132 sets the size of the jitter buffer 118 by programming or otherwise controlling the number of individual buffer entries (e.g., buffer entry 138) in the jitter buffer 118 (with each buffer entry capable of storing an audio packet). Thus, for ease of reference, the control output used by the buffer controller 132 to set the current size of the jitter buffer 118 is referred to herein as a size control signal 136. Thus, the buffer controller 132 can configure the size control signal 136 to indicate a specific size for the jitter buffer 118 or may configure the size control signal 136 to specify a particular increase or decrease of the jitter buffer 118 from its current size.

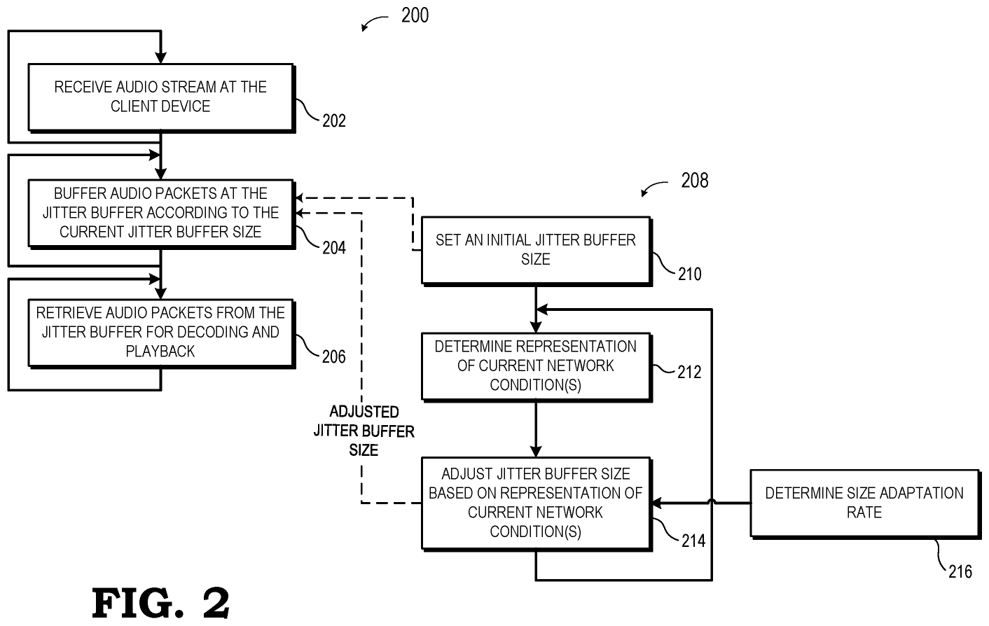

FIG. 2 illustrates an example method 200 for adaptive jitter buffer sizing to accommodate changing network conditions in accordance with some embodiments. The method 200 is described in the example context of the streaming media system 100 FIG. 1. The method 200 can be based on a configuration by a server 102 or a client device 104 and implemented by the client device 104 to decrease a delay for decoding or playback of audio content, among other examples. In the following description of the method 200, the operations performed by the client device 104 can be performed in a different order than the example order shown or at different times. Some operations can also be omitted from the method 200, and other operations can be added to the method 200. Some operations can also be repeated in the method 200 to support adaptive jitter buffer sizing.

The method 200 commences with the client device 104 launching an application to stream content from the server 102 to the client device 104. In some implementations, the client device 104 launches a real-time streaming application (e.g., a cloud-based video gaming application, a video conference application, a VoIP application, and the like) to stream audio content from the server 102 to the client device 104 in the form of the packetized audio stream 114. As described below with reference to block 210, in anticipation of receiving the packetized audio stream 114, the jitter buffer 118 is set to an initial size.

At iterations of block 202, the client device 104 receives audio packets of the packetized audio stream 114 from the server 102 via the network 106 and at iterations of block 204 the client device 104 buffers audio packets as they are received at the jitter buffer 118 of the client device 104, where the maximum number of audio packets that can be buffered at the jitter buffer 118 is based on the current size set for the jitter buffer 118. As such, any audio packet received while all buffer entries of the jitter buffer 118 are occupied results in the audio packet being dropped, which in turn results in loss of audio content and, consequently, impacts the user's experience.

At iterations of block 206, the audio decoder 120 selects an audio packet from the jitter buffer 118 based on receipt order, timestamp order, or some other selection criterium and decodes the accessed audio packet to generate a corresponding segment of the decoded audio signal 122, which can be further processed (e.g., by mixing with other audio signals) and then converted to one or more analog signals used to drive the one or more speakers 124 to affect playback of the audio content represented by the audio stream 114. The access and decoding of the audio packet at block 206 results in the freeing of the corresponding buffer entry of the jitter buffer 118, thereby allowing a new audio packet to be temporarily buffered therein.

As noted above, the size of the jitter buffer 118 (that is, the number of audio packets that can be temporarily stored at the jitter buffer 118 concurrently) relative to current network conditions of the network 106 ultimately impacts the quality of the decoded audio signal 124 as a buffer size too large relative to the jitter currently exhibited by the network 106 introduces excessive latency in the decoding of the audio packets, while a buffer size too small relative to the current jitter in the network 106 can result in too many dropped audio packets. Accordingly, method 200 includes a subprocess 208 iteratively employed by the buffer controller 132 to dynamically adapt the size of the jitter buffer 118 to the current conditions of the network 106 to achieve a suitable balance between latency and dropped packets given the current network jitter.

The subprocess 208 begins at block 210 with the buffer controller 132 setting an initial size of the jitter buffer 118 using the size control signal 136 in anticipation of the start of streaming of the audio content. In some embodiments, the initial size is set to a fixed, default size, which may be a maximum size of the jitter buffer 118, a minimum size of the jitter buffer 118, or some size in between (e.g., a default size of 50% of the maximum buffer size). In other embodiments, the initial size of the jitter buffer 118 is set based on context-specific parameters, such as parameters pertaining to the requested audio stream (e.g., bit rate, sampling rate, packet size, etc.), parameters pertaining to measured network conditions, and the like.

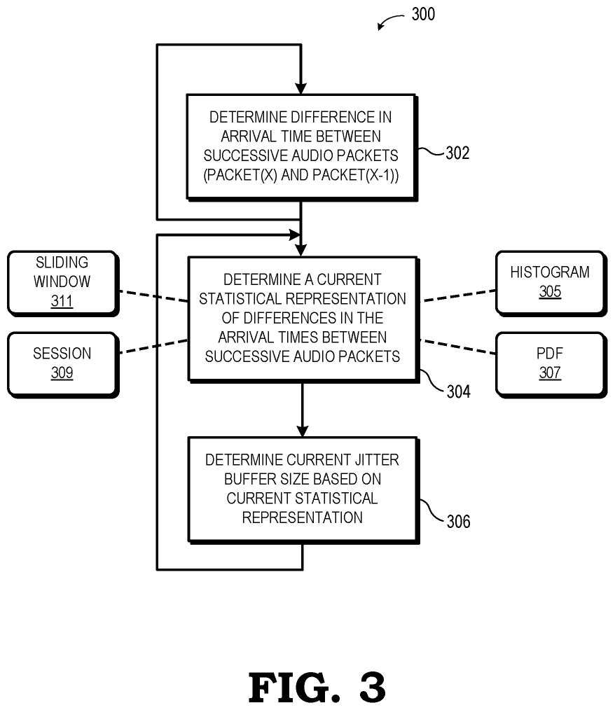

Thereafter, at block 212 the buffer controller 132 (individually or in conjunction with the network interface 116) determines one or more current network conditions for the network 106, for example, based on a representation parameter indicative of the one or more current network conditions. For example, the buffer controller 132 can determine a representation parameter indicative of a congestion level of the network based on arrival times of the audio packets. In some implementations, the buffer controller 132 determines a current network condition based on quality of service of the real-time streaming application. In some other implementations, the buffer controller 132 determines the current network condition based on data rates related to communications of the audio packets from the server 102 to the client device 104 over the network. In other implementations in which the network 106 includes a cellular network or other wireless network, the buffer controller 132 determines a current network condition based on other factors like traffic load, fading, attenuation loss and signal to noise ratio (SNR) that may have an impact on the client device 104 data rate in the network. At block 214, the buffer controller 132 uses the one or more current network conditions determined at block 212 to determine a new, or updated, size for the jitter buffer 118 to reflect the expected jitter in the arrival of audio packets as reflected by the one or more network conditions, and then sets the size control signal 136 to reconfigure the jitter buffer 118 to implement this updated size. Note that the adjustment to the size of the jitter buffer 118 may be subject to one or both of a minimum buffer size or a maximum buffer size. The process of blocks 212 and 214 may be repeated for a next iteration. An example implementation of the network condition determination process of block 212 and the jitter buffer size update process of block 214 is described below with reference to FIG. 3.

In certain situations, a rapid increase or decrease in the size of the jitter buffer 118 can disrupt the continuity of audio playback and thus degrade the audio quality. When the packetized audio stream 114 is part of a VoIP stream, the adjustment of the size of the jitter buffer at block 214 can be timed to occur during periods of silence (e.g., such as between utterances) so that the impact is reduced. However, in other situations, such as when the packetized audio stream 114 represents, for example, the audio content of a streaming video game application, there typically is continuous audio content, including continuous background music and sound effects, and thus there often are no periods of silence in which a jitter buffer size adjustment can be implemented. When the audio decoder 120 of the client device 104 exhibits audio continuity across packet boundaries during the decoding process, the jitter buffer size adjustment can be readily implemented by dropping or repeating encoded packets. However, if the number of dropped or repeated packets is relatively large over a relatively short period of time, this can also result in distortion of the audio content.

Accordingly, in some embodiments, the buffer controller 132 can tune or otherwise control the rate at which a new jitter buffer size is implemented so as to mitigate the impacts of buffer size adjustment. To this end, at block 216 the buffer controller 132 determines a size adaptation rate for the jitter buffer size adjustment determined at block 214. In particular, the buffer controller 132 can determine the size adaptation rate (or speed) S according to Equation (1):

$$S = \frac{N}{T} \qquad ( 1 )$$

where N is the number of packets to drop or repeat in the jitter buffer 118 so as to achieve the target size and T is the time duration to complete the adjustment. N is based on the difference between the current size of the jitter buffer 118 and the updated size of the jitter buffer 118, and T is a programmable value. As such, the buffer controller 132 can tune the size adaptation rate by tuning the value of T so that the adjustment becomes unperceivable. Accordingly, referring back to block 214, rather than adjusting the size of the jitter buffer 118 to the determined target buffer size all at once, the size of the jitter buffer 118 is incrementally adjusted over time until the target buffer size is reached, thereby reducing the impact of the change in buffer size. For example, if the target size is 8 buffer entries while the current size is 2 buffer entries and the adaptation time is programmed to 3 seconds, the size adaptation rate would be set to 2 buffer entries/second in accordance with Equation 1, that is: N=+6 buffer entries, T=3 seconds, and thus S=6 buffer entries/3 seconds). Accordingly, at t=0 seconds, the size of the jitter buffer 118 is increased by two buffer entries to 4 total, at t=1 seconds the size of the jitter buffer 118 is again increased by two buffer entries to 6 total, and at t=2 seconds the size of the jitter buffer 118 is yet again increased by two buffer entries to reach the target size of 8 total.

FIG. 3 illustrates an example method 300 representing the processes represented by the network condition determination process of block 212 and the jitter buffer size update process of block 214 of method 200 of FIG. 2 described above. In the example of FIG. 3, the buffer controller 132 utilizes statistical analysis of packet arrival times at the client device 104 as an indication of the current network conditions of the network 106 and adapts the size of the jitter buffer 118 based on this statistical analysis. In the following, blocks 302 and 304 represent an implementation of the block 212 of method 200 and block 306 represents a corresponding implementation of the block 214 of method 200.

Typically, as each audio packet of the audio stream 114 is received and buffered, a receipt timestamp is associated with the audio packet by either the network interface 116 or the buffer controller 132, depending on implementation. Accordingly, at block 304, with the arrival of each audio packet, the buffer controller 132 measures or otherwise determines a difference between the newly arrived audio packet X and the previously-arrived packet X−1, and stores this measured difference in arrival times in a buffer, chart, list, or other data structure. This process is repeated for each received audio packet, or some sampling thereof.

At block 304, the buffer controller 132 determines a current statistical representation of the differences in the arrival times between the successive audio packets based on some subset or all of the measurements of differences in arrival times measured at previous iterations of the arrival time difference measurement process of block 302. In some implementations, the buffer controller 132 determines the current statistical representation as a histogram 305. For example, the buffer controller 132 can generate a histogram of measured differences in the arrival time between successive packets ignoring lost packets and out of order arrival for the packets, including selecting a number of data bins for the histogram that correspond to the number of monitored packets. The histogram may thereby represent a distribution of the differences in the arrival time between successive packets and identify one or more of the following: a center (e.g., a time location) of the arrival times between successive packets, a spread (e.g., a scale) of the arrival times between successive packets; skewness of the arrival times between successive packets, a presence of outliers of the arrival times between successive packets (e.g., packets arriving later compared to other packets), and presence of multiple modes in the packets. In other implementations, the buffer controller 132 determines the current statistical representation as a probability density function (PDF) 307. The PDF 307 may provide the same statistical information that the histogram 305 but can differ in scaling the statistical information. That is, the PDF 307 can scale the statistical information differently than the histogram 305. In some embodiments, scaling all the bins of the histogram 305 such that their sum is 1 will result in the PDF 307.

It will be appreciated that the statistical analysis is performed over time. In some embodiments, the time scale for the statistical analysis includes analysis of all measured differences in packet arrival times since the start of the streaming of the packetized audio stream 114 (entire session 309). This has the benefit of providing a better representation of the steady state of the network 106 during the entire session. However, this approach has a relatively slow response to abrupt changes in the condition of the network 106. Moreover, earlier collected arrival statistics become more and more irrelevant as the session time progresses. Accordingly, in other embodiments, the statistical analysis is performed over a moving, or sliding, time window 311. In this approach, a moving time window or sample space with a size K can be used to sample for K most recent inter-arrival times to generate the statistical representation. This most recent statistics are then merged together with the previous statistics with a weight w to adjust the emphasis on the most recent statistics as opposed to the previous statistics. The merged statistics at time k may be given by Equation (2)

Pₖ(x)=(1−w)Pₖ₋₁(x)+wf(x) (2)

where f(x) is the most recent statistics from K most recent samples before merging. Pₖ(x) is the weighted probability density function of the network inter-arrival times. This probability density function can be used to adjust the jitter buffer size based on the desired target percentile. One of the benefits of this approach is that the adaptation speed can be adjusted by the client device 104. Higher adaptation speed means the client device 104 can adapt quickly to abrupt changes, including potential outliers, while slower speed makes it more robust against outliers, but unable to respond quickly to any valid abrupt changes. In other implementations, the client device 104 may determine the current statistical representation of the differences in the arrival times between the successive audio packets based on a reset event. In some other implementations, the client device 104 may generate the statistical representation since a reset event (e.g., an ending of a current audio stream or a beginning of a new audio stream).

At block 308, the buffer controller 132 selects a current jitter buffer size based on the current statistical representation, the size adaptation rate, a jitter buffer size threshold, or any combination thereof, and configures the size control signal 136 to reflect the selected size accordingly. By way of example, a histogram, such as the histogram 305 illustrated in Table 1 below, represents a jitter distribution of packets arrival time (in milliseconds (ms)). A first bin of the histogram 305 can indicate a number of packets arriving with a jitter within 20 ms, while a second bin of the histogram 305 can indicate a number of packets arriving with a jitter between 20 ms and 40 ms, etc. In some embodiments, for a target percentile, for example of 90%, the number of packets are summed until 90% of the total packets are received, which corresponds to the fourth bin (e.g., <80 ms). For the above example, each packet carries a 20 ms duration of audio. As such, the jitter buffer size, for the target percentile of 90% will be 4 (e.g., =80 ms/20 ms).

TABLE 1
Histogram

| Jitter | Number of Packets |
|---|---|
| <20 ms | 12 |
| <40 ms | 36 |
| <60 ms | 17 |
| <80 ms | 25 |
| <100 ms | 10 |

In some other embodiments, where a target percentile does not align with a bin boundary (e.g., a target percentile of 80%), the buffer controller 132 may select a next bin, to achieve a percentile greater than the target percentile. In this example, the fourth bin, in order to achieve a percentile of 90%. Alternatively, the buffer controller 132 may interpolate between the third and the fourth binds to achieve the target percentile of 80%. However, when converting the bin's jitter to a jitter buffer size, the buffer controller 132 may have to round up or down as the jitter buffer size may have to an integer value. The rounding operation may impact the achieved percentile.

In some embodiments, certain aspects of the techniques described above may implemented by one or more processors of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid state storage devices such as Flash memory, a cache, random access memory (RAM) or other non-volatile memory device or devices, and the like. The executable instructions stored on the non-transitory computer-readable storage medium may be in source code, assembly language code, object code, or other instruction format that is interpreted or otherwise executable by one or more processors.

A computer-readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc , magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method comprising:
receiving a stream of audio packets at a device via a network;
buffering audio packets of the stream at a jitter buffer of the device; and
dynamically adjusting a size of the jitter buffer based on a representation of a current condition of the network.

2. The method of claim 1, further comprising:
determining the representation of the current condition of the network based on a congestion level of the network.

3. The method of claim 1, further comprising:
determining the representation of the current condition of the network based on measured differences between arrival times of successive audio packets of the stream.

4. The method of claim 3, wherein:
determining the representation of the current condition of the network comprises determining the representation of the current condition based on a statistical analysis of the measured differences between arrival times of successive audio packets.

5. The method of claim 4, wherein the representation of the current condition comprises one of a histogram or a probability density function determined from the measured differences between arrival times of successive audio packets.

6. The method of claim 5, further comprising:
determining a first subset of audio packets of the stream of audio packets arriving within a first period based on a first bin of the histogram;
determining a second subset of audio packets of the stream of audio packets arriving between the first period and a second period based on a second bin of the histogram; and
determining a percentile of total packets received based on the first subset of audio packets and the second subset of audio packets, wherein dynamically adjusting the size of the jitter buffer comprises:
adjusting the size of the jitter buffer based on the percentile of total packets received satisfying a target percentile of total packets received.

7. The method of claim 4, wherein the statistical analysis is performed for one of:
measured differences between arrival times of successive audio packets since a start of a session for the stream; or
measured differences between arrival times of successive audio packets over a sliding time window.

8. The method of claim 4, further comprising:
selecting one or more bins of a histogram corresponding to a number of audio packets of the stream of audio packets received based on a target percentile of total packets received; and
interpolating the one or more selected bins corresponding to the number of audio packets of the stream of audio packets received, wherein dynamically adjusting the size of the jitter buffer comprises:
adjusting the size of the jitter buffer based on the interpolation, wherein a value of the interpolating number of audio packets of the stream of audio packets received comprise an integer value mapping to the size of the jitter buffer.

9. The method of claim 8, wherein the statistical analysis includes use of weighting to favor more recent measured differences over less recent measured differences.

10. The method of claim 1, further comprising:
determining a size adaptation rate for adjusting the size of the jitter buffer from a current size to a target size; and
wherein dynamically adjusting the size of the jitter buffer comprises adjusting the size of the jitter buffer to the target size at the size adaptation rate.

11. The method of claim 10, wherein the size adaptation rate is based on a programmable duration over which the size of the jitter buffer is to be adapted to the target size.

12. (canceled)

13. A non-transitory computer-readable medium storing a set of executable instructions that, when executed by at least one processor, manipulate the at least one processor to:
receive a stream of audio packets at a device via a network;
buffer audio packets of the stream at a jitter buffer of the device; and
dynamically adjust a size of the jitter buffer based on a representation of a current condition of the network.

14. A device comprising:
a network interface configured to couple to a network to receive a stream of audio packets;
a jitter buffer configured to buffer audio packets of the stream, the jitter buffer having an adjustable size; and
a buffer controller coupled to the network interface and the jitter buffer, the buffer controller configured to dynamically adjust the size of the jitter buffer based on a representation of a current condition of the network.

15. The device of claim 14, wherein the buffer controller is further configured to:
determine the representation of the current condition of the network based on measured differences between arrival times of successive audio packets of the stream.

16. The device of claim 14, wherein the buffer controller is further configured to determine the representation of the current condition based on a statistical analysis of the measured differences between arrival times of successive audio packets.

17. The device of claim 16, wherein the representation of the current condition comprises one of a histogram or a probability density function determined from the measured differences between arrival times of successive audio packets.

18. The device of claim 17, wherein the buffer controller is configured to:
determine a first subset of audio packets of the stream of audio packets arriving within a first period based on a first bin of the histogram;
determine a second subset of audio packets of the stream of audio packets arriving between the first period and a second period based on a second bin of the histogram; and
determine a percentile of total packets received based on the first subset of audio packets and the second subset of audio packets, wherein dynamically adjusting the size of the jitter buffer comprises:
adjusting the size of the jitter buffer based on the percentile of total packets received satisfying a target percentile of total packets received.

19. The device of claim 16, wherein the buffer controller is configured to perform the statistical analysis for one of:
measured differences between arrival times of successive audio packets since a start of a session for the stream; and
measured differences between arrival times of successive audio packets over a sliding time window.

20. The device of claim 14, wherein the buffer controller is further configured to:
determine a size adaptation rate for adjusting the size of the jitter buffer from a current size to a target size; and
dynamically adjust the size of the jitter buffer by adjusting the size of the jitter buffer to the target size at the size adaptation rate.

21. The device of claim 20, wherein the size adaptation rate is based on a programmable duration over which the size of the jitter buffer is to be adapted to the target size.
